(19) United States
(12) Patent Application Publication
(10) Pub. No.: US 2012/0132643 A1
(43) Pub. Date: May 31, 2012

(54) MICROHEATER AND MICROHEATER ARRAY

(75) Inventors: Jun-hee CHOI, Seongnam-si (KR); Joo-ho LEE, Hwaseong-si (KR); Mi-jeong SONG, Suwon-si (KR)

(73) Assignee: SAMSUNG ELECTRONICS CO., LTD., Suwon-si (KR)

(21) Appl. No.: 13/284,177

(22) Filed: Oct. 28, 2011

(30) Foreign Application Priority Data
Nov. 29, 2010 (KR) 10-2010-0119787

(51) Int. Cl. H05B 3/02

(52) U.S. Cl. 219/538

(57) ABSTRACT

A microheater and a microheater array are provided. The microheater includes a substrate, a column disposed on the substrate and a bridge supported by the column. A width of a portion of a bridge formed on the column is less than a width of a portion of the bridge that does not contact the column. The bridge may include a spring component.

### CROSS-REFERENCE TO RELATED APPLICATION

This application claims priority from Korean Patent Application No. 10-2010-0119787, filed on Nov. 29, 2010, in the Korean Intellectual Property Office, the disclosure of which is incorporated herein by reference in its entirety.

### BACKGROUND

1. Field

Apparatuses and methods consistent with exemplary embodiments relate to a microheater, and more particularly, to a microheater and a structure of a microheater array in which a width of a connection part between microheaters is adjusted so that the microheater array generally has a uniform temperature distribution, and to a manufacturing method thereof.

2. Description of the Related Art

A microheater is a device for locally generating heat at a desired position on a substrate. Microheaters may be used in electronic devices such as carbon nanotube transistors, polycrystalline silicon thin-film transistors, or the like, or solar cells, which utilize high temperature processes.

A microheater has a structure including a supporting unit formed on a substrate, and a bridge unit supported by the supporting unit and separated from the substrate. When power is applied to the microheater from an external source, the microheater radiates heat so that a local temperature rises.

However, heat transfer in microheaters occur according to conduction via supporting units so that a temperature of the supporting units is low whereas a bridge unit between the supporting units has a high temperature since the bridge unit does not transfer heat to an external source, except for a heat transfer according to convection or radiation. Thus, in such a microheater, temperature differences difference based on location may be high. In a case in which such a temperature difference occurs, it may be difficult to maintain a desired temperature range, and a driving voltage may increase.

### SUMMARY

One or more exemplary embodiments provide a microheater having a small internal temperature difference, whereby the microheater has a uniform temperature distribution.

One or more exemplary embodiments provide a microheater array having a uniform temperature distribution.

According to an aspect of an exemplary embodiment, a microheater includes a substrate; a column formed on the substrate; and a bridge supported by the column, being separate from the substrate and having a width that varies.

A width of a portion of the bridge that contacts the column may be less than a width of another portion of the bridge that does not contact the column.

The column may be formed of silicon oxide, silicon nitride, or insulating metal oxide.

The bridge may be formed of at least one material selected from the group consisting of molybdenum (Mo), tungsten (W), silicon carbide (SiC), platinum (Pt), and indium-tin-oxide (ITO).

The bridge may include at least one spring component.

The at least one spring component may have a donut shape.

A width of a portion of the bridge that contacts the column may be less than a width of another portion of the bridge that does not contact the column.

A plurality of the columns may be formed on the substrate, and a plurality of the bridges may be formed on the columns in parallel to each other or to cross each other.

### BRIEF DESCRIPTION OF THE DRAWINGS

These and/or other aspects and advantages will become apparent and more readily appreciated from the following description of exemplary embodiments, taken in conjunction with the accompanying drawings in which:

FIG. 1A is a perspective view of a microheater according to an exemplary embodiment;

FIG. 1B is a magnified perspective view of a region A1 of the microheater in FIG. 1A;

FIG. 2 is a perspective view of a microheater according to another exemplary embodiment;

FIGS. 3A through 3C are plane views illustrating various examples of a bridge shape on a column of a microheater; and

FIG. 4 is an image of the microheater, taken by an optical microscope, according to one or more exemplary embodiments.

### DETAILED DESCRIPTION

Reference will now be made in detail to exemplary embodiments with reference to the accompanying drawings. In the drawings, the thicknesses of layers and regions may be exaggerated for clarity of the description.

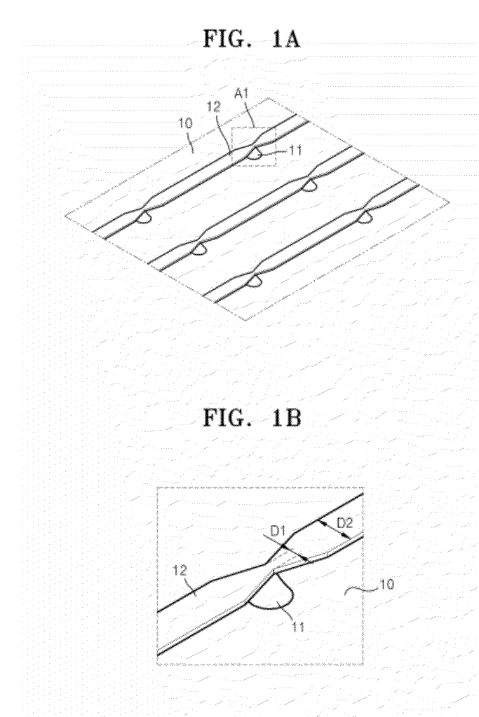

FIG. 1A is a perspective view of a microheater according to an exemplary embodiment.

Referring to FIG. 1A, a column 11 is formed on a substrate 10, and a bridge 12 is formed on the column 11. The bridge 12 may be supported by the column 11 and may be spaced apart from the substrate 10. A plurality of the columns 11 may be formed on the substrate 10, and a plurality of the bridges 12 may be supported by the columns 11 and may be formed in parallel, forming an array. A distance between the substrate 10 and the bridge 12 may be selected according to the particular application, and arrangements other than the parallel formation shown in FIG. 1A may be used. For example, the bridges 12 may intersect or may be disposed one over another by adjusting heights of the columns 11.

FIG. 1B is a magnified perspective view of a region A1 of the microheater in FIG. 1A.

Referring to FIG. 1B, it is possible to see that in an which is supported by the column 11, a width of the bridge 12 is decreased. In the microheater according to the present embodiment, a width Dl of a portion of the bridge 12 that contacts the column 11 is less than a width D2 of a portion of the bridge 12 that does not contact the column 11 (i.e., D1<D2). This provides a more even heat distribution. If a width of the bridge 12 is the same for all areas, excessive heat transfer occurs via the column 11, and a temperature of the portion of the bridge 12 that contacts the column 11 becomes lower than a temperature of the portion of the bridge 12 that is between the columns 11. In such a case, it might be difficult to control the overall temperature of the microheater, resulting in wasted driving power.

In the microheater according to the present embodiment, in order to minimize heat loss via the column 11, the width D1 of the portion of the bridge 12 that contacts the column 11 is decreased to prevent excessive heat loss. In the portion of the bridge 12 that is between the columns 11, there is no heat loss other than that which occurs due to convection or radiation. In general, heat of an element is proportional to a resistance of the element, and if a width of the bridge 12 is decreased, the resistance and the generated heat increase. Thus, by decreasing the width D1 of the portion of the bridge 12 that contacts the column 11, a uniform temperature may be maintained in the bridge 12 although a small heat transfer occurs via the column 11. A difference ratio (D1/D2) of widths of the bridge 12 may be selected according to application.

The substrate 10 may be formed of a material including silicon, silicon oxide, silicon nitride, or the like, which are used to form substrates of semiconductor devices, and may be formed of a glass material. The column 11 may be formed of a material having a low thermal conductivity so as to prevent a loss of heat generated in the bridge 12, and may be formed of an insulating material such as silicon oxide, silicon nitride, or another metal oxide. The bridge 12 may be formed of molybdenum (Mo), tungsten (W), silicon carbide (SiC), platinum (Pt) or indium-tin-oxide (ITO), and may have a single-layer structure or a multi-layer structure including one or more materials which radiate heat in response to a power applied thereto. When power is applied to the bridge 12, heat in a visible ray region or an infrared region may be radiated.

A method of manufacturing a microheater, according to an exemplary embodiment will now be described.

First, an insulating material such as silicon oxide or silicon nitride having a low thermal conductivity is coated on a substrate, formed of one of silicon, silicon oxide, silicon nitride, and glass so as to form columns on the substrate. Then, a conductive material including Mo, W, SiC, Pt, or ITO is coated on the insulating material. Next, the conductive material is etched so that bridges having a desired shape are formed. After a predetermined patterning operation is performed, the insulating material other than the columns is removed via an isotropic etching process. The aforementioned method may be performed by using a semiconductor manufacturing process.

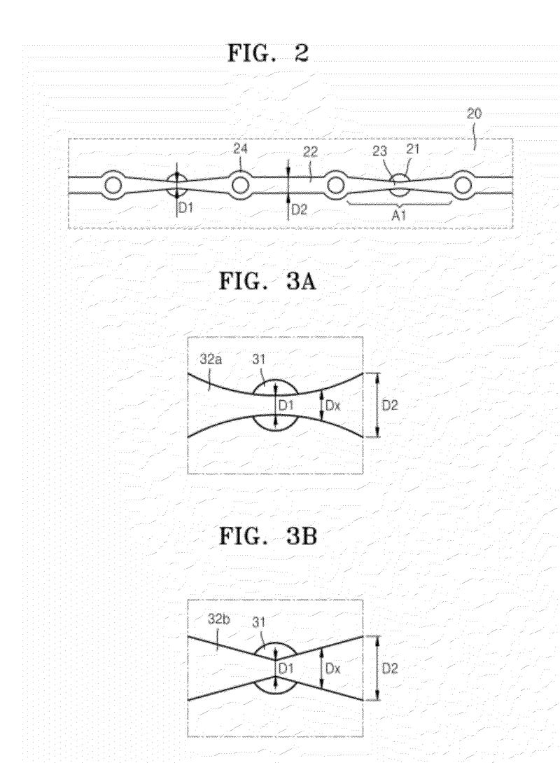

FIG. 2 is a perspective view of a microheater according to another exemplary embodiment.

Referring to FIG. 2, a column 21 is formed on a substrate 20, and bridges 22 and 23 are formed on the column 21. The bridges 22 and 23 may improve a structural stability of the microheater and may further include one or more spring components 24 so as to increase a heat value. The spring component 24 may have a donut shape and may be formed in regions of the bridges 22 and 23 at both sides of the column 21. A width D1 of a portion of the bridge 23 that contacts the column 21 may be less than a width D2 of a portion of the bridge 22 between the spring components 24.

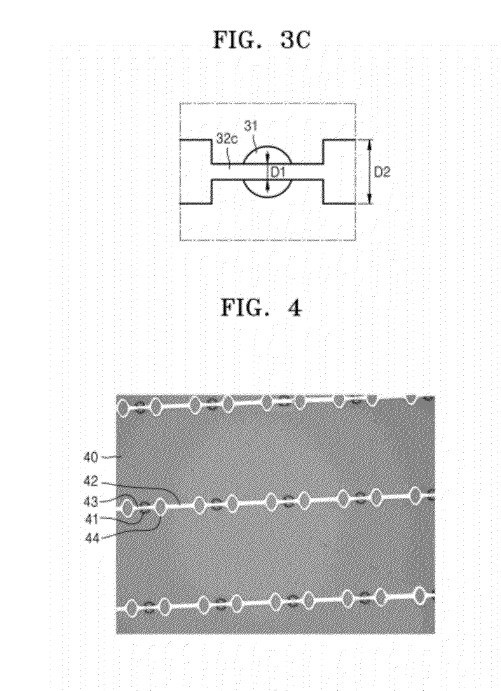

FIGS. 3A through 3C are plane views illustrating various examples of a bridge shape on a column of a microheater.

Referring to FIGS. 3A through 3C, bridges 32a, 32b, and 32c are formed on a column 31, and a width D1 of a portion of each of the bridges 32a, 32b, and 32c that is on the column 31 is less than a width D2 of a portion of each of the bridges 32a, 32b, and 32c that is not on the column 31.

In the structures shown in FIGS. 3A and 3B, a width Dx of each of the bridges 32a and 32b gradually varies, and in the structure shown in FIG. 3C, the bridge 32c has a stepped-shape.

In the structure of FIG. 3A, a shape of the bridge 32a has a curved-shape, and in the structure of FIG. 3B, the shapes of both sides of the bridge 32b are linear.

The bridge may have shapes with changing widths other than those shown in FIGS. 3A through 3C. For example, the shape of the bridge may be curved and have a linear cross-section, or may have a plurality of steps toward a column.

However, regardless of a shape of the bridge, a microheater according to one or more exemplary embodiments may include any bridge in which widths of the bridge vary.

FIG. 4 is an image of the microheater taken with an optical microscope according to one or more exemplary embodiments. The microheater having a structure shown in FIG. 4 is obtained by forming columns using silicon oxide and by forming bridges using Mo. In the microheater of FIG. 4, a width of a portion of the bridge that contacts the column is 3 μm, and a width of a portion of the bridge between spring components is 10 μm.

Referring to FIG. 4, a column 41 is formed on a substrate 40, bridges 42 and 43 are formed on the column 41, and a spring component 44 is formed between the bridges 42 and 43. A width of a portion of the bridge 43 that contacts the column 41 is less than a width of the bridge 42 between springs 44.

A level of heat radiation and light emission in each region of the microheater may be determined using a charge-coupled device (CCD) image, and in a microheater according to one or more exemplary embodiments, a region of a bridge contacting a column has a relatively small width so that the microheater may have a uniform temperature distribution.

According to one or more exemplary embodiments, the microheater may have a uniform temperature distribution in its columns and bridges.

Also, according to one or more exemplary embodiments, a microheater array may include microheaters having a uniform temperature distribution.

It should be understood that the exemplary embodiments described herein should be considered in a descriptive sense only and not for purposes of limitation. Descriptions of features or aspects with respect to the exemplary embodiments should be considered as available for other similar features or aspects in other exemplary embodiments, so that an example of a microheater in which a width of a bridge is changed, and a width of a portion of the bridge that contacts a column is reduced may belong to the scope of one or more of the exemplary embodiments.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A microheater comprising:
a substrate;
a column disposed on the substrate; and
a bridge supported by the column, wherein a width of the bridge in a first region is different from a width of the bridge in a second region.

2. The microheater of claim 1, wherein the first region of the bridge contacts the column and the width of the first region is less than the width of the second region of the bridge which does not contact the column.

3. The microheater of claim 1, wherein the column is formed of one of silicon oxide, silicon nitride, and insulating metal oxide.

4. The microheater of claim 1, wherein the bridge is formed of at least one material selected from a group consisting of molybdenum (Mo), tungsten (W), silicon carbide (SiC), platinum (Pt), and indium-tin-oxide (ITO).

5. The microheater of claim 1, wherein the bridge comprises at least one spring component.

6. The microheater of claim 5, wherein the at least one spring component has a donut shape.

7. The microheater of claim 5, wherein the first region of the bridge contacts the column and the width of the first region is less than the width of the second region of the bridge which does not contact the column.

8. The microheater of claim 5, wherein the column is formed of one of silicon oxide, silicon nitride, and insulating metal oxide.

9. The microheater of claim 5, wherein the bridge is formed of at least one material selected from the group consisting of molybdenum (Mo), tungsten (W), silicon carbide (SiC), platinum (Pt), and indium-tin-oxide (ITO).

10. The microheater of claim 1, wherein a plurality of the columns are formed on the substrate, and
wherein a plurality of the bridges are formed on the columns.

11. The microheater of claim 10, wherein the first region of the bridge contacts the column and the width of the first region is less than the width of the second region of the bridge which does not contact the column.

12. The microheater of claim 10, wherein the bridge comprises at least one spring component.

13. The microheater of claim 12, wherein the first region of the bridge contacts the column and the width of the first region is less than the width of the second region of the bridge which does not contact the column.

14. A microheater comprising:
a substrate,
a plurality of columns disposed on the substrate;
a bridge supported by the plurality of columns, wherein the bridge comprises first regions which contact the columns and at least one second region which is disposed between first regions;
wherein a width of the first regions is less than a width of the at least one second region.

15. The microheater of claim 14, wherein a width of the bridge changes gradually between each of the first regions and the at least one second region.

16. The microheater of claim 14, wherein a width of the bridge changes abruptly between each of the first regions and the at least one second region, such that a step is formed between each of the first regions and the at least one second region.

17. The microheater of claim 14, further comprising a donut-shaped spring portion disposed in the second region.
